(19) United States
(12) Patent Application Publication
(10) Pub. No.: US 2002/0022896 A1
(43) Pub. Date: Feb. 21, 2002

(54) Queuing methods and apparatus

(76) Inventor: Valerie G. Dugan, Tarrytown, NY (US)

Correspondence Address: VALERIE G. DUGAN, DUGAN & DUGAN, 18 JOHN STREET, TARRYTOWN, NY, 10591, US

(21) Appl. No.: 09/923,099

(22) Filed: Aug. 6, 2001

Related U.S. Application Data
(60) Provisional application No. 60/223,371, filed on Aug. 7, 2000.

(51) Int. Cl. G05B 15/00; G05B 23/02; G08B 1/00; G08B 23/00

(52) U.S. Cl. 700/83; 340/3.7; 340/286.06; 340/573.1

(57) ABSTRACT

In a first aspect, a system is provided for queuing people that are to use a bathroom. The system includes (1) a controller; (2) a monitoring device coupled to the controller and adapted to monitor occupancy of a bathroom; and (3) computer program code operative with the controller. The computer code is operative with the controller so as to allow the controller to (1) receive a request to use the bathroom from a user; (2) enter the user in a bathroom queue; and (3) notify the user when the user should proceed to the bathroom.

This patent application claims priority from U.S. Provisional Patent Application Ser. No. 60/223,371, filed Aug. 7, 2000, which is hereby incorporated by reference herein in its entirety.

### FIELD OF THE INVENTION

The present invention relates to queuing methods and apparatus.

### BACKGROUND OF THE INVENTION

On an airplane flight, waiting for a bathroom to become vacant can be both unpleasant and dangerous. For example, to obtain a position in a bathroom line or “queue”, a traveler typically must leave his/her seat and wait in line. While in line, other travelers may try to crowd ahead of the traveler, may need to pass the traveler (e.g., to get back to their seats), or may otherwise disturb the traveler. Likewise, waiting in a bathroom line on an airplane is dangerous as the traveler is not in his/her seat with a fastened seat belt (e.g., the traveler may be injured if the airplane travels through turbulent airspace). While usually not dangerous, waiting in line for any public bathroom (e.g., in a restaurant) can be similarly unpleasant.

Other unenjoyable experiences associated with an airplane flight include (1) waiting to get off of the airplane after the airplane lands; (2) trying to get an upgrade on an airplane; and (3) waiting to obtain checked luggage. All of these activities typically require some type of “queuing” activity. Accordingly, a need exists for improved methods and apparatus for queuing.

### SUMMARY OF THE INVENTION

In accordance with the present invention, methods, systems, apparatus and computer program products are provided for improving queuing.

In a first aspect of the invention, a system is provided for queuing people that are to use a bathroom. The system includes (1) a controller; (2) a monitoring device coupled to the controller and adapted to monitor occupancy of a bathroom; and (3) computer program code operative with the controller. The computer code is operative with the controller so as to allow the controller to (1) receive a request to use the bathroom from a user; (2) enter the user in a bathroom queue; and (3) notify the user when the user should proceed to the bathroom.

In a second aspect of the invention, a system is provided for queuing. The system includes a controller and computer program code operative with the controller so as to allow the controller to (1) receive a request from a user to participate in a preferred queue for an event associated with an airplane flight; (2) allow the user to purchase a position in the preferred queue; and (3) notify the user if the user is selected to participate in the preferred queue for the event. Numerous other embodiments are provided, as are apparatus, methods and computer program products. Each computer program product may be carried by a medium readable by a computer (e.g., a carrier wave signal, a floppy disc, a hard drive, a random access memory, etc.).

Other objects, features and aspects of the present invention will become more fully apparent from the following detailed description, the appended claims and the accompanying drawings.

### BRIEF DESCRIPTION OF THE DRAWINGS

FIG. 1 is a schematic diagram of a first exemplary queuing system configured in accordance with the present invention; and

FIG. 2 is a schematic diagram of a second exemplary queuing system configured in accordance with the present invention.

### DETAILED DESCRIPTION

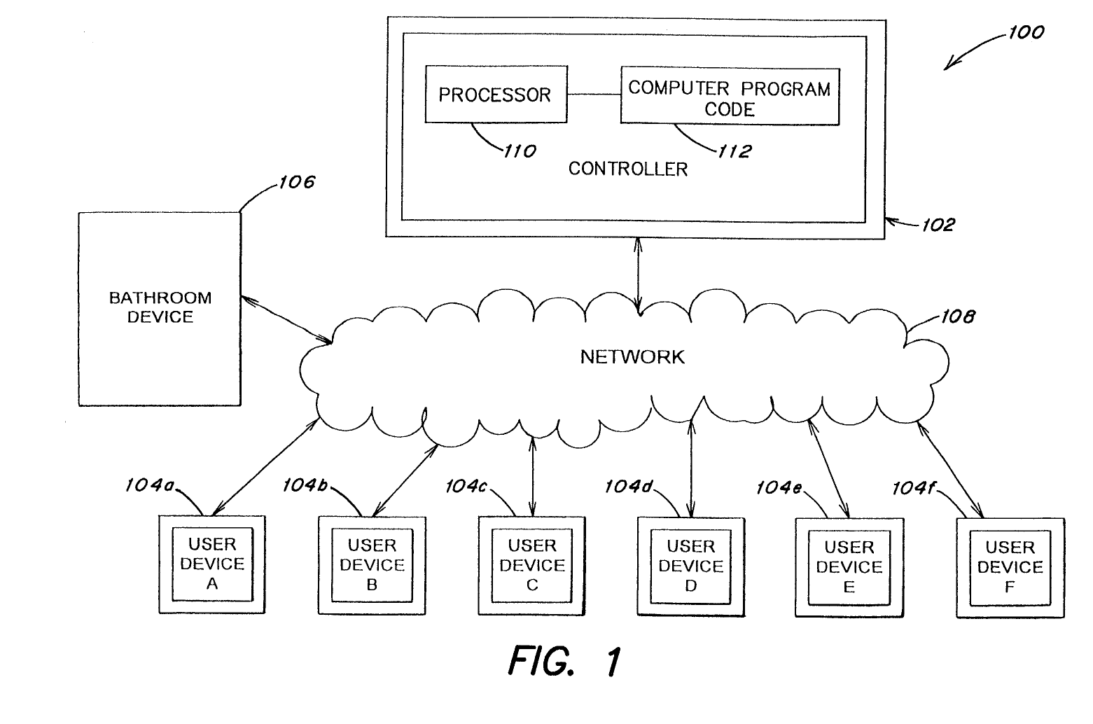

With reference to FIG. 1, a first exemplary queuing system 100 is shown that may be employed for queuing people that wish to use a bathroom. Specifically, the system 100 allows a user to:

1. reserve a position in a bathroom queue without leaving his/her seat;

2. be notified when the user is within a predetermined time of gaining access to the bathroom (e.g., when the user is “next” in line for the bathroom) or should otherwise proceed to the bathroom;

3. pay to move higher in the bathroom queue (e.g., pay to use the bathroom sooner); and/or

4. be provided with a code that allows the user access to the bathroom only when it is the user's turn (e.g., to prevent others from “crowding ahead” of the user).

With reference the FIG. 1, the system 100 includes a controller 102 coupled to a plurality of user devices 104a-f and to a bathroom device 106 via a network 108. In general, the network 108 may comprise any communications medium such as the Internet, an Intranet, an extranet, a telephone network, a direct connection, a wireless network, a cellular network, or the like. While six user devices 104a-f are shown, it will be understood that any number of user devices 104a-f may be employed as may any number of bathroom devices. The user devices 104a-f may comprise one or more personal digital assistants (PDAs), one or more computers (e.g., laptop computers), one or more telephones, one or more cellular telephones (e.g., a conventional telephone or an airplane telephone located, for example, on the back of an airplane's seat), or any other suitable device.

As described further below, the bathroom device 106 is employed, for example, to monitor the occupancy of one or more bathrooms (not shown) such as a bathroom in an airplane or in a restaurant, and to communicate bathroom occupancy information to the controller 102 via the network 108. The bathroom device 106 may comprise any conventional monitoring mechanism such as a door switch, a motion detector, a light beam detection circuit (e.g., a circuit that determines whether a light beam strikes a photodetector, and if the light beam is broken as a person enters/exits a bathroom), etc. The bathroom device 106 may further comprise a locking mechanism (not shown) that may be used to prevent a person from entering a bathroom if another person is within the bathroom, and/or if the person does not enter a code (e.g., a programmable code set by the controller 102 and provided to the person when it is the person's turn to use the bathroom).

The controller 102 comprises a processor 110 (e.g., one or more conventional microprocessors) and computer program code 112 that allows the controller 102 to communicate with one or more users via one or more of the user devices 104a-f and with the bathroom device 106. The computer program code 112 may be, for example, operative with the processor 110 to:

1. allow a user to employ one or more of the user devices 104a-f to enter a bathroom queue (e.g., by actuating a key, by dialing a telephone number, by pressing a button, by flipping a switch, etc.);

2. allow a user to receive a number/position in the queue (e.g., by displaying the number/position on one of the user devices 104a-f);

3. allow a user to receive a code that can be entered at the bathroom device 106 to gain access to a bathroom (not shown) associated with the bathroom device 106;

4. allow a user to make a payment to “jump ahead” in the bathroom queue;

5. allow a user to receive an alarm that indicates that the user is about to be given access to the bathroom (e.g., if the user is next in line);

6. allow a user to be removed from the bathroom queue (e.g., if the user no longer wishes to use the bathroom);

7. verify that a code entered at the bathroom device 106 is the correct code for the user;

8. direct the bathroom device 106 to allow the user entry to the bathroom; and/or

9. perform any other similar operations.

As an example, assume that a traveler is sitting in a seat on an airplane and decides that she would like to use a bathroom. Rather than unbuckling her seatbelt, leaving her seat and standing in line (e.g., physically entering the bathroom queue), the traveler may notify the controller 102 of her desire to enter the bathroom queue (e.g., by pressing a button on her chair or on an airplane telephone (located on the seat in front of her), or by using any other suitable user device 104a-f). In response to the notification from the traveler, the controller 102 places the traveler in the bathroom queue. When a bathroom is about to become free (e.g., when the traveler is next in line for the bathroom), the controller 102 sends the traveler (e.g., via a display on one of the user devices 104a-f) a message that, for example, (1) indicates that the traveler can enter the next available bathroom; and (2) provides the traveler with a code that the traveler may enter into the bathroom device 106 to gain access to the bathroom. The traveler then may proceed to the bathroom, and if it is vacant, enter the code and enter the bathroom. In this manner, the traveler need never leave her seat until a bathroom is available (or is about to become available). Note that it may be desirable to give the traveler a limited amount of time to enter the bathroom, especially if the bathroom queue is very long.

In addition to bathroom queuing, it may be desirable to allow a traveler to enter a queue that determines the order in which travelers may board/unboard a plane, the order in which travelers check-in for a flight and/or the order in which travelers may get luggage from an over head compartment or from a baggage claim area. In such embodiments, travelers may, for example, “bid” to be the first on or off a plane, the first to receive their baggage, etc. A system similar to the system 100 or any other system may be employed.

In another aspect, it may be desirable to allow a traveler to “bid” for an upgrade. For example, if numerous first class or business class seats are open on a flight, either before a traveler boards a flight or after the traveler boards the flight, the traveler may bid against other travelers to obtain a first class or business class seat. Travelers could bid via any mechanism (e.g., a kiosk, a PDA, a laptop, a WEB site, a telephone, a cellular telephone, an airplane telephone, a keypad of an airplane seat, etc.). Levels of upgrade may be provided. For example, for $50 a person may sit in first class but will receive coach class services, for $100 a person may sit in business class and receive business class services, for $150 a person may sit in first class and receive first class services except for free drinks and a movie, for $200 a person may sit in first class and receive all first class benefits. Any of the above prices may be determined by an auction (e.g., wherein travelers set the prices), or via a Mercata-type system wherein a price decreases as more people take advantage of the upgrades.

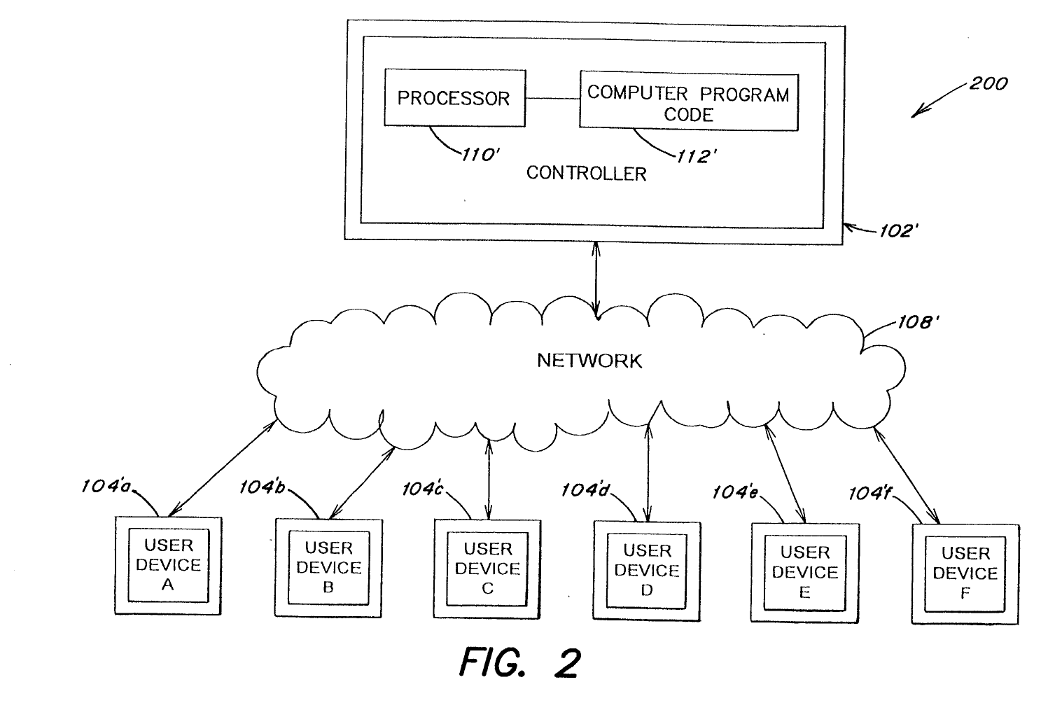

FIG. 2 is a schematic diagram of a second exemplary system 200 configured for preferred queuing for an event associated with an airplane flight in accordance with the present invention. The system 200 of FIG. 2 is similar to the system 100 of FIG. 1, but does not employ the bathroom device 106.

In the system 200 of FIG. 2, a controller 102′ also is provided that includes a processor 110′ (e.g., one or more conventional microprocessors) and computer program code 112′ that allows the controller 102′ to communicate with one or more users via one or more user devices 104′a-f. The computer program code 112′ may be, for example, operative with the processor 110′ to:

1. receive a request from a user to participate in a preferred queue for an event associated with an airplane flight (e.g., boarding/unboarding a plane, receiving an upgrade, checking-in, etc.);

2. allow the user to purchase a position in the preferred queue (e.g., bid for a better position during boarding/unboarding or check-in, bid for an upgrade, etc.);

3. notify the user if the user is selected to participate in the preferred queue for the event; and/or

4. allow any other similar operations.

While six user devices 104′a-f are shown, it will be understood that any number of user devices 104′a-f may be employed. The user devices 104′a-f may comprise one or more personal digital assistants (PDAs), one or more computers (e.g., laptop computers), one or more telephones, one or more cellular telephones (e.g., a conventional telephone or an airplane telephone located, for example, on the back of an airplane's seat), or any other suitable device.

A system similar to system 100 or system 200 may be used to control the queuing of a public telephone (e.g., in an airport, in a train station, etc.), the queuing of a dinner table at a restaurant, etc.

The foregoing description discloses only exemplary embodiments of the invention. Modifications of the above disclosed apparatus and method which fall within the scope of the invention will be readily apparent to those of ordinary skill in the art. For instance, information regarding the location of a bathroom (e.g., a map) also may be provided to a user. Accordingly, while the present invention has been disclosed in connection with exemplary embodiments thereof, it should be understood that other embodiments may fall within the spirit and scope of the invention, as defined by the following claims.

The invention claimed is:

1. A system for queuing people that are to use a bathroom, the system comprising:
a controller;
a monitoring device coupled to the controller and adapted to monitor occupancy of a bathroom; and
computer program code operative with the controller so as to allow the controller to:
receive a request to use the bathroom from a user;
enter the user in a bathroom queue; and
notify the user when the user should proceed to the bathroom.

2. The system of claim 1 wherein the monitoring device is selected from the group consisting of a door switch, a motion detector and a light beam detection circuit.

3. The system of claim 1 further comprising computer program code operative with the controller so as to allow the controller to:
communicate a position of the user within the bathroom queue to the user.

4. The system of claim 1 further comprising computer program code operative with the controller so as to allow the controller to:
allow the user to pay to move higher in the bathroom queue.

5. The system of claim 1 further comprising:
a locking device coupled to the controller and adapted to:
lock the bathroom; and
unlock the bathroom only after receiving a code; and
computer program code operative with the controller so as to allow the controller to:
provide a code to unlock the bathroom to the user.

6. The system of claim 5 wherein the controller is configured to provide the code to the user when the user is within a predetermined time period of using the bathroom.

7. The system of claim 5 wherein the controller is configured to provide the code to the user when the user is next in line to use the bathroom.

8. The system of claim 5 further comprising computer program code operative with the controller so as to allow the controller to:
prevent the locking device from unlocking the bathroom after receiving a code unless the code is assigned to a user that is next in line to use the bathroom.

9. The system of claim 1 further comprising computer program code operative with the controller so as to allow the controller to:
provide location information regarding the bathroom.

10. A system for queuing people that are to use a bathroom of an airplane, the system comprising:
a controller;
a plurality of user devices coupled to the controller and located within the airplane;
a monitoring device coupled to the controller and adapted to monitor occupancy of a bathroom of the airplane; and
computer program code operative with the controller so as to allow the controller to:
receive a request to use the bathroom from a user;
enter the user in a bathroom queue;
monitor occupancy of the bathroom; and
notify the user when the user should proceed to the bathroom.

11. The system of claim 10 wherein the user devices are coupled to seats of the airplane.

12. An apparatus comprising:
a processor; and
computer program code operative with the processor for allowing the processor to:
receive a request from a user to enter a bathroom queue; and
notify the user when the user is next to use a bathroom.

13. A method comprising:
receiving a request to use a bathroom from a user, the request being sent via a user device;
entering the user in a bathroom queue; and
notifying the user via the user device when the user should proceed to the bathroom.

14. The method of claim 13 wherein the bathroom is on an airplane and wherein the user device is attached to a seat of the airplane.

15. A system for queuing comprising:
a controller;
computer program code operative with the controller so as to allow the controller to:
receive a request from a user to participate in a preferred queue for an event associated with an airplane flight;
allow the user to purchase a position in the preferred queue; and
notify the user if the user is selected to participate in the preferred queue for the event.

16. The system of claim 15 wherein the event is boarding or unboarding an airplane.

17. The system of claim 15 wherein the event is checking in for the airplane flight.

18. The system of claim 15 wherein the event is receiving an upgrade.

19. The system of claim 18 further comprising computer program code operative with the controller so as to allow the controller to offer a number of levels of upgrade.

20. A method comprising:
receiving a request from a user to participate in a preferred queue for an event associated with an airplane flight, the request being sent via a user device;
allowing the user to purchase a position in the preferred queue; and
notifying the user via the user device if the user is selected to participate in the preferred queue for the event.
